(19) United States
(12) Patent Application Publication
(10) Pub. No.: US 2021/0130243 A1
(43) Pub. Date: May 6, 2021

(54) FIBER POROSITY FORMING FILLERS IN THERMAL SPRAY POWDERS AND COATINGS AND METHOD MAKING AND USING THE SAME

(71) Applicant: OERLIKON METCO (US) INC., Westbury, NY (US)

(72) Inventor: Scott WILSON, Zurich (CH)

(73) Assignee: OERLIKON METCO (US) INC., Westbury, NY (US)

(21) Appl. No.: 16/484,386

(22) PCT Filed: Feb. 15, 2018
(86) PCT No.: PCT/US2018/018373

§ 371 Date: Aug. 7, 2019

Related U.S. Application Data
(60) Provisional application No. 62/460,350, filed on Feb. 17, 2017.

(51) Int. Cl. C04B 38/06; C23C 4/10; C04B 35/622

(52) U.S. Cl. CPC C04B 38/068; C23C 4/10; F01D 5/288; C04B 38/067; C04B 38/0675; C04B 35/62222

(57) ABSTRACT

Thermal spray powder including a metal and/or ceramic powder composition and porosity forming fibers and/or fiber agglomerates mixed within or with the powder composition. An exemplary TBC or abradable thermal spray coating can be made by the thermal spray powder.

### CROSS-REFERENCE TO RELATED APPLICATIONS

The instant application is a PCT International Application claiming the benefit of U.S. provisional application No. 62/460,350 filed on Feb. 17, 2017, the disclosure of which is hereby expressly incorporated by reference thereto in its entirety.

### BACKGROUND OF THE INVENTION

### 1. Field of the Invention

This invention relates to thermal spray powders and thermal spray coating using the same which include fibers (or fibres) of fiber fillers that are configured to provide porosity in the coating. The coating may be a thermal barrier coating (TBC) or an abradable coating such as that used in e.g., turbine engines. The porosity can result from subjecting the coating to heat treatment after the coating is applied.

### 2. Discussion of Background Information

Thermal barrier coatings are well known including those with vertical cracks. There are numerous publications and patents disclosing thermal barrier coatings with vertical cracks. However, such coatings typically have a dense microstructure. For example, U.S. Pat. No. 5,073,433 to Taylor and U.S. Pat. No. 8,197,950 to Taylor et al. disclose segmented coatings having a density of 5.47 g/cc to 5.55 g/cc which is greater than 88% of the theoretical density. The disclosure of each of these US patents is herein expressly incorporated by reference in its entirety.

Abradable coatings, abradable TBC and comparable structures are also well known and are described in the following documents, each of which is herein expressly incorporated by reference in their entireties: US 2009/0060747 to STROCK et al, U.S. Pat. No. 4,094,673 to ERICKSON et al., U.S. Pat. No. 4,818,630 to BEATON, U.S. Pat. No. 3,936,656 to MIDDLETON, U.S. Pat. No. 5,326,647 to MERZ et al., US 2012/0276352 to LIU et al., U.S. Pat. No. 5,849,416 to COFFINBERRY et al., US 2006/0251515 to LANDIS, US 2011/0316179 to DOMAGOLSKI et al., as well as JPH01147118(A), GB791568(A), CN105483597, JP2011167995(A), CN101518968, JPH0239932(A), GB821690(A), CN105565835(A), CN105524503(A), ZA201206205(B), CA2717827(A1), CN101195937(A) and JPH01230475(A).

Functional filler materials that are known to be used in abradable coatings include polyester or liquid crystal polyester (LCP) or polyamide powders, hexagonal boron nitride, polyesters combined with hexagonal boron nitride powders and graphite powders. Porosity formers for high service temperature abradables are also known and include polyester (LCP) powders, which typically require burnout at 500° C./3 h after coating deposition.

There are, however, disadvantages with these materials. In the case of functional filler materials for abradables, the disadvantages associated with such materials is their lightweight nature which makes them tend to segregate when blended with powders having a higher density and makes them difficult to handle and size (sieve) to desired size specification. In addition, small variations in weight percent correspond to comparatively large volume changes. This impacts spray reproducibility and the ability to meet a desired target porosity.

### SUMMARY OF THE INVENTION

It would be advantageous to replace the known fillers or porosity formers with fibers in accordance with the invention.

It would be advantageous to form one or more coating layers with fibers in accordance with the invention.

The invention thus relates to any one or more of the herein claimed powders, coatings and/or methods such as power and/or coating that includes fibers as porosity formers. The coating can be thermal barrier coating (TBC) and/or an abradable coating having porosity formed by the fibers.

In accordance with non-limiting aspects of the invention, fibers are incorporated into a coating microstructure e.g. during thermal spray process, however, which can form a loosely packed structure in the microstructure after deposition. The “inefficient packing” of fibers introduces a level of porosity into the microstructure and thereby introduces properties and functions such as; tailored or predetermined levels of porosity and gas or liquid permeability, tailored or predetermined levels of friability (brittleness) and resultant bulk hardness of the coating microstructure which assists the low energy cutting removal processes (improves abradability) against turbomachinery blade tips when they cut into the abradable coated shroud, thereby reducing or preventing blade wear.

In accordance with non-limiting aspects of the invention, fibers are used which are agglomerates of fibers that can fulfill the same porosity role as is used in known coatings that create porosity with non-fiber fillers or porosity formers. An advantage of using fibers is that they can be of varying size, length and material and can be combined to tailor the level of coating porosity, or friability. Additionally or alternatively, they can provide other functions such as improved oxidation, corrosion, erosion or sintering resistance. The agglomerates of fibers can be manufactured by several well-known methods, such as spray drying and mechanical cladding using an organic or inorganic binder e.g. PVA (polyvinyl alcohols). In addition, the fibers can be agglomerated together with other non-fibrous materials to tailor different functions, such as agglomerate of fibers+metal+binder, where the metal is, for example, very fine zinc, e.g., particles of size range 0.10 to 2.00 μm plus or minus 0.05 μm, that improves corrosion inhibition/ resistance, or a very fine, e.g., particles of size range 0.10 to 2.00 μm plus or minus 0.05 μm, molybdenum to improve corrosion resistance and lubricity, or nickel, iron or cobalt based alloys to adjust density of fiber agglomerates, or very fine, e.g., particles of size range 0.10 to 2.00 μm plus or minus 0.05 μm, nickel to improve corrosion resistance and/or to adjust density of fiber agglomerates.

The agglomerates of fibers can also be agglomerates of fibers+compound+binder, where compound is one or more metal phosphates or metal chromates e.g. zinc phosphate, to improve corrosion inhibition

The agglomerates of fibers can also be agglomerates of fibers+ceramic+binder, where the ceramic is fine hexagonal boron nitride (hBN) and/or calcium fluoride (CaF) to improve oxidation and lubricity/friability, or Yttrium oxide (oxidation resistance, density), or Ytterbium oxide (oxidation resistance, density), or various albite or illite ceramic clays as described in CA2358624 (C) or counterpart U.S. Pat. No. 7,267,889 to Hajmrle et al., as inorganic binders.

The agglomerates of fibers can also be agglomerates of fibers+organic filler or binder, where the binder is one or more low melting point or degradation temperature organic binders such as PVA which remain mechanically stable during the thermal spray deposition process, but degrade upon exposure to heat e.g. 200-250° C. The result being that the fibers in the agglomerates, along with any other functional constituents, are released into the coating microstructure by de-bonding from each other, thereby producing an in-situ porosity in the coating microstructure.

Non-limiting examples of the fibers or fibrous materials that can be used in accordance with the invention include carbon fibers (PAN or polyacrylonitrile) or (Acrylonitrile precursor) such as that generally sourced as milled short fiber typically 10 micrometers (um) in diameter and 150-200 micrometers in length. They can be milled to even finer sizes. The carbon fibers can also be clad with a thin layer of a metal, for example nickel. Typical fiber length is 150 micrometers, typical fiber diameter can be 10 micrometers+/−5 micrometers, minimum fiber length is 20 micrometers, and maximum fiber length is 300 micrometers. The carbon fibers can also be milled and broken down into an angular particle (powder) morphology with typical diameter of 5 micrometers, with a max of 10 micrometers and a min of 0.5 micrometers.

As used herein, a fiber means an elongate structure of non-metallic or non-ceramic material whose diameter or cross-sectional shape is generally uniform along a length direction and whose length is two or more times its diameter. Non-limiting examples of the diameter (average diameter) is typically measured in micrometers. Non-limiting lengths are from four or more times the fiber diameter to twenty or more times the fiber diameter. The fibers may be of an organic material, may be coated or uncoated, and may be generally solid, i.e., non-hollow or non-tubular.

As used herein, an agglomerate of fibers or agglomerates of fibers means a clump or clumps of fibers which typically include from 50 to 500 in number of fibers which remain clumped to one another with an organic or inorganic chemical binder. Non-limiting examples of the sizes (average diameter) for each clump is between 50 and 200 microns. Non-limiting examples of the relative size difference between the clumps and the powder spray material can be between 10 and 100 microns. Non-limiting examples of the relative density difference between the clumps and the powder spray material can be between 1.0 and 8.0 g/cm³.

As used herein, an agglomerate of fibers/powder or agglomerates of fibers and powders means a clump or clumps of fibers and powder particles which typically include from 10 to 500 in number of fibers and from 10 to 100 in number of powder particles which remain clumped to one another. Non-limiting examples of the sizes (average diameter) for each clump is between 40 and 200 microns. Non-limiting examples of the relative size difference between the clumps and the powder spray material can be between 10 and 100 microns. Non-limiting examples of the relative density difference between the clumps and the powder spray material can be between 1.0 and 8.0 g/cm³.

Non-limiting examples of the fibers or fibrous materials that can be used in accordance with the invention include fibrous polymeric materials formed by melt spun liquid crystal polyesters (LCP) such as polyesters of 6-hydroxy-2-napthioc acid and para-hydroxy benzoic acid (and variations thereof) as described in U.S. Pat. No. 4,161,470 Jul. 17, 1979. Because of the high melting point of this family of polyesters, typically 300-310° C., they have a high viscosity during the melt spinning process and have larger fiber diameters than common low melting point polyesters used in the textile industry. Typical fiber length is 150-300 micrometers, typical fiber diameter is 15 micrometers+/−5 micrometers, minimum fiber length is 50 micrometers and maximum fiber length is 400 micrometers.

Non-limiting examples of the fibers or fibrous materials that can be used in accordance with the invention also include polyaramid fibers e.g., Kevlar(R).

Non-limiting examples of the fibers or fibrous materials that can be used in accordance with the invention also include natural fibers such as bamboo and flax. Others are hemp, jute, ramie, sisal, cotton, coir, abaca (manila hemp). Bamboo can be used that has a typical fiber diameter of 6-12 micrometers+/−5 micrometers, Flax can be used with a typical fiber diameter of 12-20 μm+/−5 micrometers with a minimum fiber length of 100 micrometers and a maximum fiber length of 3000 micrometers. Natural fibers can also be of the type discussed in Plant Fibers for Textile and Technical Applications by M. Sfiligoj Smole, S. Hribernik, K. Stana Kleinschek and T. Kre\hat{z}e, DOI: 10.5772/52372 and book entitled Advances in Agrophysical Research edited by Stanislaw Grundas and Andrzej Stepniewski, ISBN 978-953-51-1184-9, Published: Jul. 31, 2013. The entire disclosures of these sources are herein expressly incorporated by reference.

Non-limiting examples of the fibers or fibrous materials that can be used in accordance with the invention also include metal or metal alloy fibers such as low carbon steel or stainless steel fibers, pure iron fibers, nickel or iron alloy fibers, e.g. with Hastelloy X, or FeCrAl or FeCrAlY compositions, copper fibers, brass, e.g. 65/35 brass fibers, chromium fibers. The typical fiber diameter is 6-500 μm, with a minimum fiber length of 6 millimeters and a maximum fiber length of 60 millimeters.

Non-limiting examples of the fibers or fibrous materials that can be used in accordance with the invention also include ceramic fibers such as magnesium aluminate spinels, ytrria, ytterbium, lanthanum or dysprosia stabilized zirconias (and combinations of these stabilizers), ytterbia disilicate, calcium fluoride, alumina and alumina based compositions, titanium dioxide and titanium oxide based compositions, silicon, and ceramic compositions described in U.S. Pat. No. 7,462,393 with a typical fiber diameter of 3-30 μm, a minimum fiber length of 10 millimeters, and a maximum fiber length of 100 millimeters.

Non-limiting examples of the matrix materials that can be used with the fibers or fibrous materials include non-fibrous matrix materials such as aluminum alloys (e.g. AlSi) currently used in commercially available abradables: typical particle size 30-150 μm, nickel (e.g. NiCrFe, NiCrAl, NiCrAlY and NiCoCrAlY) and cobalt alloys (e.g. CoNiCrAlY) currently used in commercially available abradables: and utilizing a typical particle size 5-100 μm. The matrix materials can also include zirconia based ceramics currently used in commercially available abradables and TBCs (e.g. Dysprosia-stabilized ZrO2 and Yttria-stabilized rO2) with a typical particle size of 10-150 μum as well as iron based alloys such as FeCrAl and FeCrAlY with a typical particle size of 5-100 μum

Non-limiting examples of the binder that can be used with the fibers or fibrous materials include organic binders such as polyvinylpyrrolidone (PVP), also commonly called polyvidone or povidone, polyvinyl alcohols (PVA), carboxymethyl cellulose (CMC), starches, dextrin, polylactic acid (PLA), polyethylene glycols (PEG)

Non-limiting examples of the binder that can be used with the fibers or fibrous materials include inorganic binders such as sodium silicate, magnesium aluminum silicates and bentonite.

Non-limiting examples of the thermal spray techniques and processes include combustion, plasma spray, High Velocity Oxygen Fuel (HVOF), Cold gas, Wire arc, Suspension plasma, etc.

The invention can also be directed to the use of fiber based or fibrous morphology materials which can be tailored to introduce unique functions in abradable and TBC coatings with the main aim of introducing porosity and in the case of abradables, cutting ability of metallic alloy, intermetallic and ceramic based abradable coatings by turbomachinery blades. For both TBCs and abradables, fibers or fibrous materials can be used to produce unique tailored and reproducible levels of porosity, porosity distribution and pore morphologies to provide desired levels of thermal conductivity, thermal cycle resistance, mechanical toughness and resistance to erosive impact damage by solid particles.

The invention can also be directed to a thermal spray powder comprising a powder composition comprising a metal material, a ceramic material, or a metal material and a ceramic material. Porosity forming fibers can be included with the porosity forming fibers being mixed with said powder composition.

In embodiments, the fibers comprise fibers configured to provide, in a formed coating, at least one of varying or different porosities and/or varying or different friability.

In embodiments, the fibers comprise fibers configured to provide, in a formed coating, at least one of a predetermined level of oxidation resistance, a predetermined level of corrosion resistance, a predetermined level of erosion resistance and/or a predetermined level of sintering resistance.

In embodiments, the fibers comprise fibers of at least one of varying or different diameters, varying or different lengths and/or varying or different materials.

In embodiments, the fibers are at least one of coated fibers, non-metal fibers with a metal coating, carbon fibers with a Ni coating and/or agglomerates of fibers.

In embodiments, the fibers comprise agglomerates of fibers that comprise fibers held together with a binder.

In embodiments, the binder is one of an organic binder, an inorganic binder, or PVA.

In embodiments, the metal material is at least one of zinc, molybdenum, nickel, iron, and/or cobalt.

In embodiments, the fibers comprise agglomerates made of fibers that include fibers, a metal component, and a binder.

In embodiments, the binder is one of an organic binder, an inorganic binder, or PVA.

In embodiments, the fibers comprise agglomerates of fibers that include fibers, a corrosion inhibiting material, and a binder.

In embodiments, the corrosion inhibiting material is at least one of a metal phosphate, a metal chromate and/or zinc phosphate.

In embodiments, the fibers comprise agglomerates of fibers that include fibers, a ceramic material, and a binder.

In embodiments, the ceramic material is at least one of hexagonal boron nitride, calcium fluoride, yttrium oxide, ytterbium oxide, albite ceramic clay and/or illite ceramic clay.

In embodiments, the fibers comprise agglomerates of fibers that include fibers and either an organic filler or an organic binder.

In embodiments, the fibers comprise at least one of carbon fibers, polymeric fibers, polyaramid fibers, natural fibers, plant or textile fibers.

In embodiments, the fibers comprise at least one of carbon fibers, polymeric fibers, polyaramid fibers, natural fibers, plant or textile fibers, metal or metal alloy fibers and/or ceramic fibers.

In embodiments, the fibers comprise at least one of an average length of 100 to 300 micrometers, an average diameter of 0.5 to 500 micrometers and/or a minimum fiber length of 50 micrometers and a maximum fiber length of 3000 micrometers.

In embodiments, the thermal spray powder comprises a powder composition comprising at least one of a metal material and a ceramic material and agglomerates of fibers mixed with said powder composition.

In embodiments, the thermal spray coating made by the powder of any one of ways described above.

In embodiments, the thermal spray coating is one of a TBC coating and an abradable coating.

In embodiments, a TBC or abradable thermal spray coating comprises at least one layer of a material composition that includes a metal or a ceramic, wherein said layer has an arrangement of fibers in said layer.

In embodiments, a TBC or abradable thermal spray coating comprises at least one layer of a material composition that includes a metal or a ceramic, wherein said layer has fiber agglomerates disposed in said layer.

In embodiments, a TBC or abradable thermal spray coating comprises at least one layer of a material composition that includes a metal or a ceramic, wherein said layer has a predetermined level of porosity resulting from fibers being at least partially burned out of said layer.

In embodiments, a TBC or abradable thermal spray coating comprises at least one layer of a material composition that includes a metal or a ceramic, wherein said layer has a predetermined level of porosity resulting from fiber agglomerates being at least partially burned out of said layer.

In embodiments, a TBC or abradable thermal spray coating comprises at least one layer of a metal or ceramic material composition, wherein said layer has a predetermined level of porosity resulting from fibers being permanently disposed in said layer. In embodiments, the areas or zones with fibers permanently disposed therein are areas or zones of lower or different density than the surrounding coating layer.

In embodiments, a TBC or abradable thermal spray coating comprises at least one layer of a metal or ceramic material composition, wherein said layer has a predetermined level of porosity resulting from fiber agglomerates being permanently disposed in said layer. In embodiments, the areas or zones with fibers permanently disposed therein are areas or zones of lower or different density than the surrounding coating layer.

In embodiments, a method of coating a substrate using the powder of any one of types described above, includes applying a coating on a substrate by thermal spraying the powder and depositing a coating material on the substrate.

In embodiments, a method of applying a TBC coating or an abradable coating on a substrate using the powder of any one of types described above includes applying a coating on a substrate by thermal spraying the powder and depositing a coating material on the substrate.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows how a powder (ceramic and/or metal) can be mixed with fibers to form a mixture or blend of powder and fibers;

FIG. 2 shows a thermal sprayed coating layer made from the mixture or blend of FIG. 1;

FIG. 3 shows the applied thermal spray coating layer of FIG. 2 after a heat or sintering treatment that burns out the fibers in the coating and leaves a porous microstructure;

FIG. 4 shows a thermal spray material formed of agglomerates or clumps which are formed of powder particles (ceramic and/or metal powder particles) mixed or blended with loose fibers to form powder/fiber agglomerates—with each agglomerate containing fibers and powder particles adhered to one another;

FIG. 5 shows a thermal sprayed coating layer made from the agglomerates of FIG. 4;

FIG. 6 shows the applied thermal spray coating layer of FIG. 5 after a heat or sintering treatment that burns out the fibers in the coating and leaves a porous microstructure;

FIG. 7 shows a fiber only agglomerate with each agglomerate containing fibers adhered to one another with organic or inorganic binder;

FIG. 8 shows an applied thermal spray coating made by the thermal spraying the thermal spray powder containing the fiber agglomerates;

FIG. 9 shows a fiber and non-fiber component agglomerate—with each agglomerate containing fibers adhered to one another with organic or inorganic binder and including non-fiber components such as metal and/or ceramic compound components;

FIG. 10 shows an applied thermal spray coating made by the thermal spraying the thermal spray powder containing the agglomerates of FIG. 9;

FIG. 11 shows powder particles (ceramic and/or metal powder particles) mixed or blended with loosely-adhered fibers to form a thermal spray powder;

FIG. 12 shows an applied thermal spray coating made by the thermal spraying the thermal spray powder of FIG. 11;

FIG. 13 shows the applied thermal spray coating of FIG. 12 after a heat or sintering treatment that burns out the fibers in the coating and leaves a porous microstructure;

FIG. 14 shows a scanning electron microscope (SEM) cross-section of an applied thermal sprayed abradable coating of FeCrAlY matrix alloy having carbon fiber agglomerates which have melted and formed dark regions similar to those of FIG. 7 in accordance with the invention at a scale of 100 μm and prior to heat treatment;

FIG. 15 shows the scanning electron microscope (SEM) cross-section of FIG. 14 at a scale of 50 μm;

FIG. 16 shows carbon fiber raw material at a 200 μm scale; and

FIG. 17 shows agglomerates at a 100 μm scale (pre-milled) made of milled fibers and an organic binder and agglomerated using a spray dried process.

### DETAILED DESCRIPTION OF THE INVENTION

### EXAMPLE A

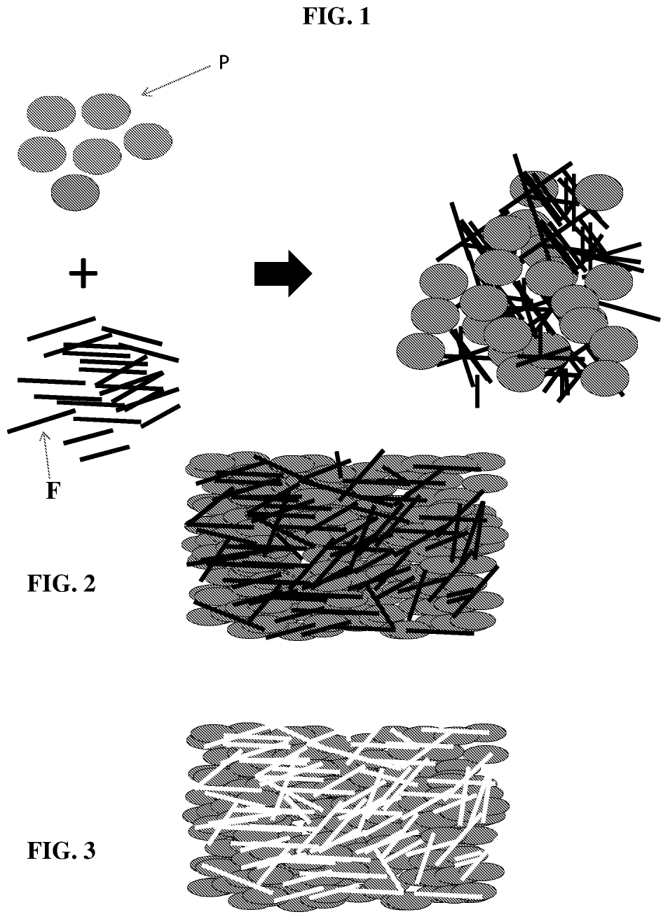

FIGS. 1-3 show powder and coating formation in accordance with one embodiment of the invention. FIG. 1 shows how a ceramic and/or metal powder particles P (left side) can be mixed or blended with loose fibers to form a blended mixture of powder particles and loose fibers (right side). This blended mixture can then serve as a thermal spray powder. The fibers can have an average length of 100 to 300 micrometers and an average diameter of 0.5 to 500 micrometers. In addition, the fibers can have a minimum fiber length of 50 micrometers and a maximum fiber length of 3000 micrometers. The fibers can be, for example, coated fibers, non-metal fibers with a metal coating and/or carbon fibers with a Ni coating.

FIG. 2 schematically shows an applied thermal spray coating made by the thermal spraying the thermal spray powder mixture shown in FIG. 1. In reality, the fibers shown in FIG. 2 would have melted and changed shape. However, the locations of the fibers imply a relatively even distribution of within the coating layer.

FIG. 3 shows the applied thermal spray coating of FIG. 2 after a heat or sintering treatment which burns out the fibers in the coating and leaves a porous microstructure. This coating can have a predetermined pore diameter architecture (utilizing both an even distribution of pores and extending throughout the coating) and which are sufficiently arranged so that the coating can function as, e.g., filtration membrane.

### EXAMPLE B

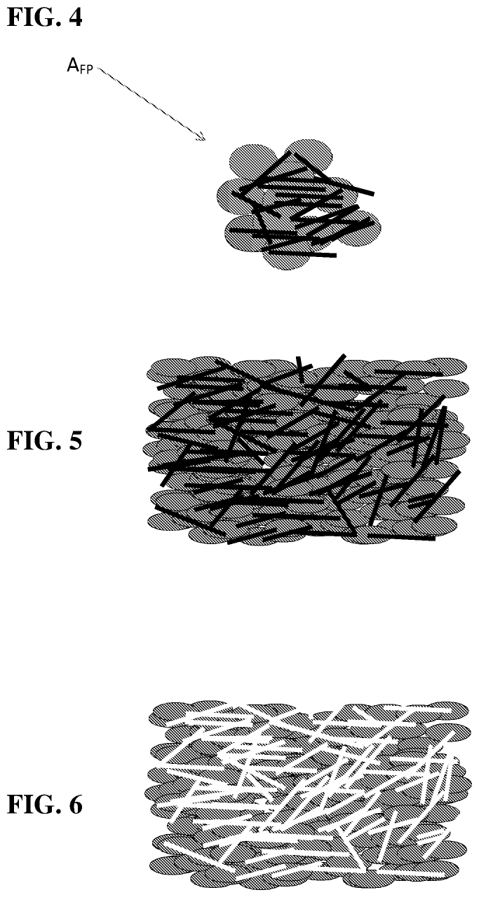

FIGS. 4-6 shows powder and coating formation in accordance with another embodiment of the invention. FIG. 4 shows how ceramic and/or metal powder particles can be mixed or blended with loose fibers to form powder agglomerates A_{FP}—with each agglomerate A_{FP} containing fibers and powder particles adhered to one another. The agglomerates A_{FP} can be formed by spray drying or mechanical agglomeration. These agglomerates A_{FP} can then serve as a thermal spray powder. Alternatively, these agglomerates A_{FP} can be mixed or blended with a powder material.

FIG. 5 shows an applied thermal spray coating made by the thermal spraying the thermal spray powder formed of agglomerates A_{FP}. In reality, the fibers shown in FIG. 4 would have melted and changed shape. However, the locations of the fibers imply a relatively even distribution of within the coating layer.

FIG. 6 shows the applied thermal spray coating of FIG. 5 after a heat or sintering treatment that burns out the fibers in the coating and leaves a porous microstructure. This coating can have a defined pore diameter architecture so that the coating can function as, e.g., filtration membrane. This coating can have a predetermined pore diameter architecture (utilizing both an even distribution of pores and extending throughout the coating) and which are sufficiently arranged so that the coating can function as, e.g., filtration membrane.

### EXAMPLE C

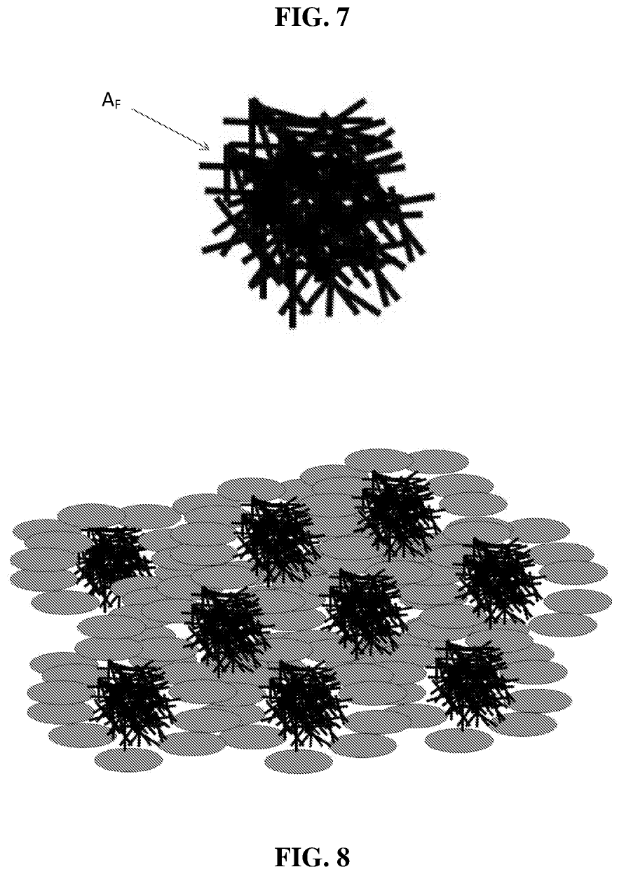

FIGS. 7-8 shows powder and coating formation in accordance with another embodiment of the invention. FIG. 7 shows a fiber agglomerate A_{F}—with each agglomerate A_{F} containing fibers adhered to one another with, for example, an organic or inorganic binder. The fiber agglomerates A_{F} can be mixed or blended with ceramic and/or metal powder particles to form a thermal spray powder (not shown).

FIG. 8 shows an applied thermal spray coating made by the thermal spraying the thermal spray powder containing the fiber agglomerates of FIG. 7. Although not shown, the applied thermal spray coating can then be subjected to a heat or sintering treatment that burns out the fiber agglomerates in the coating and leaves a porous microstructure—with pores being located where the fiber agglomerates were burned out. This coating can have a defined pore structure or porosity so that the coating can function as, e.g., a TBC abradable coating.

### EXAMPLE D

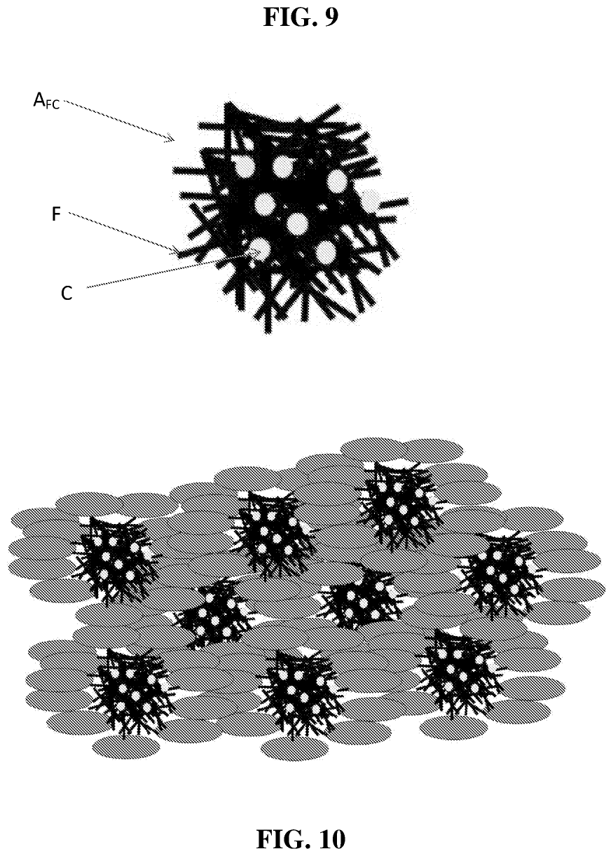

FIGS. 9-10 shows powder and coating formation in accordance with another embodiment of the invention. FIG. 9 shows a fiber and non-fiber component agglomerate A_{FC}—with each agglomerate A_{FC} containing fibers adhered to one another with, e.g., an organic or inorganic binder, and including non-fiber components C such as metal and/or ceramic compound components C in the form of particles. The agglomerates A_{FC} can be mixed or blended with ceramic and/or metal powder particles to form a thermal spray powder (not shown). In this example, the non-fiber components C arranged in the agglomerates A_{FC} can typically be of smaller particles than the powder material with which the agglomerates A_{FC} are mixed or blended.

FIG. 10 shows an applied thermal spray coating made by the thermal spraying the thermal spray powder containing the agglomerates A_{FC} mixed or blended therewith. Although not shown, the applied thermal spray coating can then be subjected to a heat or sintering treatment that burns out the fibers of the agglomerates in the coating and leaves a porous microstructure with the compound components in at least a partially melted state and inside the pores. This coating can have a defined pore structure or porosity so that the coating can function as, e.g., a TBC abradable coating.

### EXAMPLE E

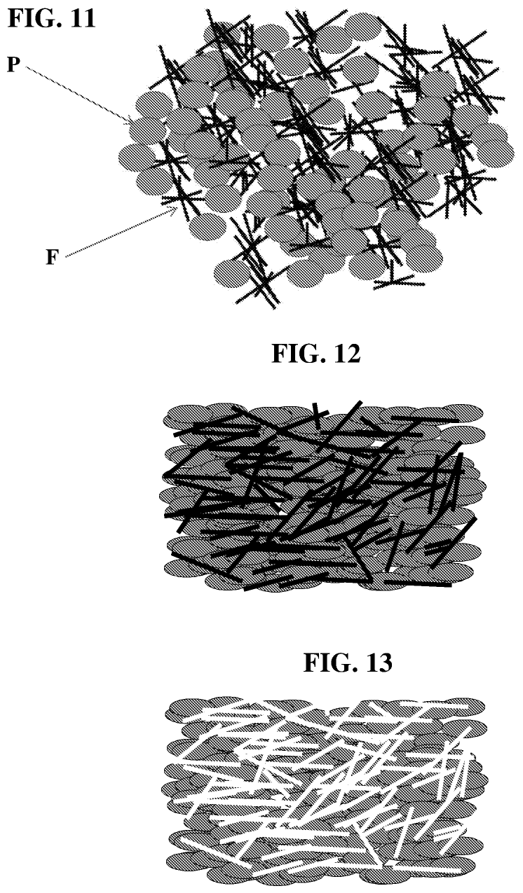

FIGS. 11-13 show a powder and coating formation in accordance with another embodiment of the invention. FIG. 11 shows how ceramic and/or metal powder particles P can be mixed or blended with loosely-adhered fibers F to form a thermal spray powder.

FIG. 12 shows an applied thermal spray coating made by the thermal spraying the thermal spray powder of FIG. 11. FIG. 13 shows the applied thermal spray coating of FIG. 12 after a heat or sintering treatment that burns out the fibers in the coating and leaves a porous microstructure. This coating can have a defined pore diameter architecture so that the coating can function as, e.g., filtration membrane.

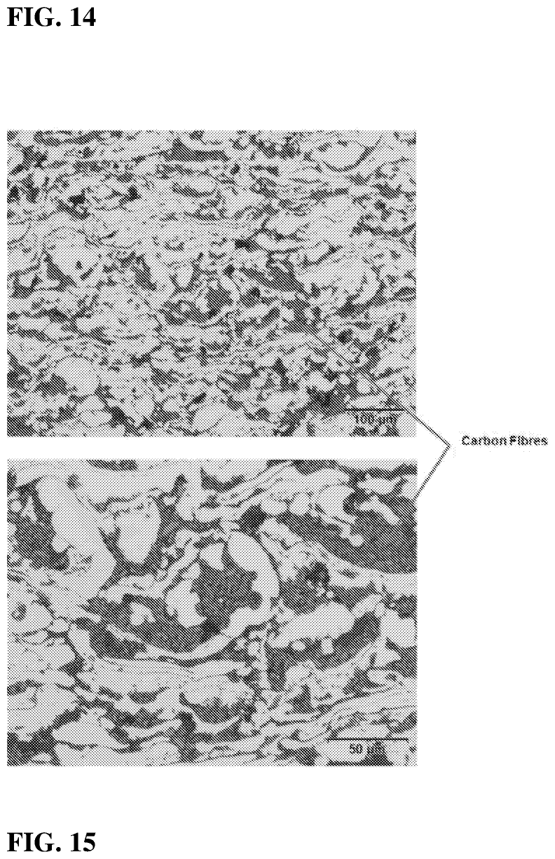

FIGS. 14 and 15 show an applied coating (in a pre-sintered or pre-heat treated state) in accordance with one of the herein noted Examples showing an abradable thermal sprayed coating microstructure of FeCrAlY matrix alloy with carbon fiber agglomerates. FIG. 14 shows a scanning electron microscope SEM) cross-section at a scale of 100 μm and FIG. 15 shows the same coating at a scale of 50

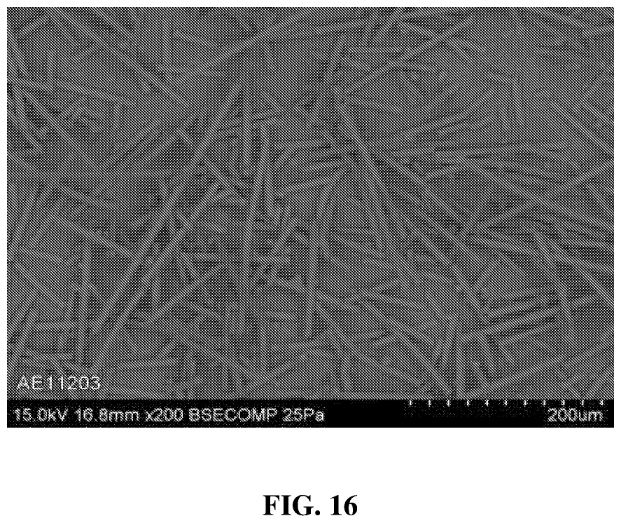

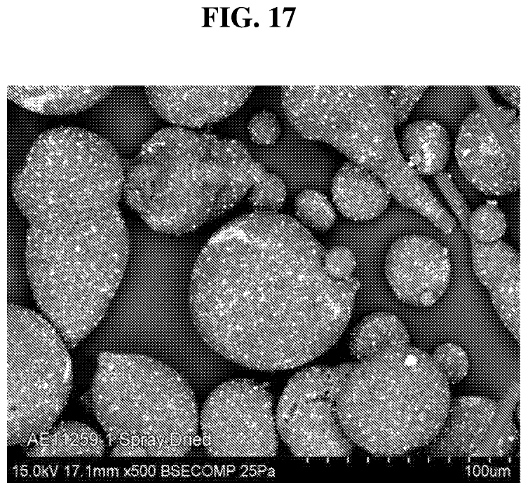

FIG. 16 shows loose carbon fiber raw material at a 200 μm scale and FIG. 17 shows agglomerates at a 100 μm scale (pre-milled) made of milled fibers and an organic binder and agglomerated using a spray dried process.

Non-limiting examples of fibers and fiber agglomerates include those described above and in the pending claims.

Non-limiting examples of powder materials or compositions that can be mixed with the fibers include those used in the incorporated prior art documents as well as those discussed herein or which are conventionally known.

Non-limiting examples of powder materials or compositions and of coatings formed therewith include those used in the incorporated prior art documents as well as those shown in the figures.

Further, at least because the invention is disclosed herein in a manner that enables one to make and use it, by virtue of the disclosure of particular exemplary embodiments, such as for simplicity or efficiency, for example, the invention can be practiced in the absence of any step, additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1-45. (canceled)

46. A TBC car abradable thermal spray coating comprising at least one layer of a material composition that includes a metal or a ceramic, wherein said layer has a predetermined level of porosity resulting from at least one of fibers or fiber agglomerates being at least partially burned out of said layer.

47. The TBC or abradable thermal spray coating of claim 45, wherein the fibers comprise fibers of at least one of: varying or different diameters; varying or different lengths; and/or varying or different materials.

48. The TBC or abradable thermal spray coating of claim 45, wherein the fibers are at least one of: coated fibers; non-metal fibers with a metal coating; carbon fibers with a Ni coating; and/or agglomerates of fibers.

49. The TBC or abradable thermal spray coating of claim 45, wherein the fiber agglomerates are held together with a binder.

50. The TBC or abradable thermal spray coating of claim 49, wherein the binder is one of: an organic binder; an inorganic hinder; PVA,

51. The TBC or abradable thermal spray coating of claim 45, wherein the metal material composition is one of: zinc; molybdenum; nickel; iron; and/or cobalt.

52. The TBC abradable thermal spray coating of claim 45, wherein the fiber agglomerates comprise fibers, a metal component, and a binder.

53. The TBC or abradable thermal spray coating of claim 52, wherein the binder is one of: an organic binder; an inorganic binder; PVA.

54. New The TBC or abradable thermal spray coating of claim 45, wherein the metal material composition is one of: zinc; molybdenum; nickel; iron; and/or cobalt.

55. The TBC or abradable thermal spray coating of claim 45, wherein the fiber agglomerates include fibers, a corrosion inhibiting material, and a binder.

56. The TBC or abradable thermal spray coating of claim 55, wherein the corrosion inhibiting material is one of: a metal phosphate; a metal chromate; and/or zinc phosphate.

57. The TBC or abradable thermal spray coating of claim 45, wherein the fiber agglomerates include fibers, a ceramic material, and a binder.

58. The TBC or abradable thermal spray coating of claim 45, wherein the ceramic material composition is one of: hexagonal boron nitride; calcium fluoride; yttrium oxide; ytterbium oxide; albite; and/or illite ceramic clay.

59. The TBC or abradable thermal spray coating of claim 45, wherein the fiber agglomerates include fibers and either an organic filler or an organic binder.

60. The TBC or abradable thermal spray coating of claim 59, wherein the fibers comprise at least one of: carbon fibers; polymeric fibers; polyaramid fibers; natural fibers; plant or textile fibers; metal or metal alloy fibers; and/or ceramic fibers.

61. The TBC or abradable thermal spray coating of claim 60, wherein the fibers comprise at least one of: an average length of 100 to 300 micrometers; an average diameter of 0.5 to 500 micrometers; a minimum fiber length of 50 micrometers; and/or a maximum fiber length of 3000 micrometers.

62. The TBC or abradable thermal spray coating of claim 45, wherein the fibers comprise at least one of: an average length of 100 to 300 micrometers; an average diameter of 0.5 to 500 micrometers; a minimum fiber length of 50 micrometers; and/or a maximum fiber length of 3000 micrometers.
